(19) United States
(12) Patent Application Publication
(10) Pub. No.: US 2024/0265163 A1
(43) Pub. Date: Aug. 8, 2024

(54) A MODELING METHOD AND APPARATUS OF A CONSTRUCTION MACHINERY EQUIPMENT

(71) Applicants: JIANGSU XCMG CONSTRUCTION MACHINERY RESEARCH INSTITUTE LTD., Xuzhou (CN); JIANGSU XCMG STATE KEY LABORATORY TECHNOLOGY CO., LTD., Xuzhou (CN)

(72) Inventors: Yongji LIU, Xuzhou (CN); Jian LIU, Xuzhou (CN); Weiwei WU, Xuzhou (CN)

(21) Appl. No.: 18/565,051

(22) PCT Filed: Jan. 16, 2023
(86) PCT No.: PCT/CN2023/072267

§ 371 Date: Nov. 28, 2023

(30) Foreign Application Priority Data
Oct. 20, 2022 (CN) 202211285652.5

(51) Int. Cl. G06F 30/17

(52) U.S. Cl. CPC G06F 30/17

(57) ABSTRACT

The present disclosure belongs to the technical field of engineering machinery and relates to an engineering machinery equipment modeling method and apparatus. The engineering machinery equipment modeling method comprises the following steps: in response to a modeling request of a user, determining a subsystem that matches the user from a plurality of subsystems of the engineering machinery equipment; displaying to the user a modeling page of the subsystem that matches the user; constructing a model of the subsystem of the engineering machinery equipment on the modeling page on the basis of a model library which can be used by the user; and adding the subsystem model of the engineering machinery equipment into the model library. Modeling efficiency of engineering machinery equipment can be improved by means of the present method.

### CROSS-REFERENCE TO RELATED APPLICATIONS

The present application is a U.S. National Stage Application of International Patent Application No. PCT/CN2023/072267, filed Jan. 16, 2023, and claims priority to the Chinese patent application No. 202211285652.5, filed Oct. 20, 2022, the disclosures of which are incorporated herein by reference in their entireties.

### TECHNICAL FIELD

The present disclosure relates to a technical field of construction machinery, particularly to a modeling method and apparatus of a construction machinery equipment.

### BACKGROUND

With the development of energy-saving and consumption-reducing technology, more and more modeling and simulation analysis methods are applied to construction machinery. When modeling analysis is performed on the construction machinery, since modeling related to a plurality of systems such as a hydraulic system, a control system and an electrical system, has high professional requirements for users in a plurality of fields, there is great difficulty in the modeling of a whole vehicle system. The more complex the whole vehicle model is, the lower the efficiency of the modeling of the whole vehicle is, so that working efficiency is influenced.

Currently, in the field of the construction machinery, modeling analysis mostly depends on standalone-version software, for example, Simulink, AMESim (Advanced Modeling Environment for performing Simulation of engineering systems), ADAMS (Automatic Dynamic Analysis of Mechanical Systems), ANSYS (Analysis system), and the like.

### SUMMARY

The present disclosure provides a modeling method and apparatus of a construction machinery equipment.

According to a first aspect of the present disclosure, there is provided a modeling method of a construction machinery equipment, comprising: in response to a modeling request of a user, determining a subsystem matched with the user from a plurality of subsystems of the construction machinery equipment; presenting, to the user, a modeling page of the subsystem matched with the user; building, on the modeling page, a model of the subsystem of the construction machinery equipment based on a model library callable for the user, wherein the model library comprises at least one of a published model of the subsystem matched with the user, a published model of another subsystem, or a published component; and adding the model of the subsystem of the construction machinery equipment into the model library.

In some embodiments, the determining a subsystem matched with the user from a plurality of subsystems of the construction machinery equipment comprises: determining a construction machinery equipment selected by the user from construction machinery equipment of various types presented on a page according to a selection operation of the user for the construction machinery equipment; acquiring modeling authority information of the user; and determining the subsystem matched with the user from the plurality of subsystems of the construction machinery equipment selected by the user according to the modeling permission information of the user.

In some embodiments, the determining a subsystem matched with the user from a plurality of subsystems of the construction machinery equipment comprises: acquiring modeling permission information of the user; and determining the subsystem matched with the user from the plurality of subsystems of the construction machinery equipment according to the modeling permission information of the user.

In some embodiments, the building, on the modeling page, a model of the subsystem of the construction machinery equipment based on a model library callable for the user comprises: presenting a first modeling page after detecting a triggering operation for a first modeling mode; presenting, on the first modeling page, a model selected by the user from the model library callable for the user; and according to a parameter setting or modification instruction of the user, performing parameter setting or modification on the model selected by the user from the model library callable for the user, to obtain the model of the subsystem of the construction machinery equipment.

In some embodiments, the building, on the modeling page, a model of the subsystem of the construction machinery equipment based on a model library callable for the user further comprises: presenting a second modeling page after detecting a triggering operation for a second modeling mode; presenting, on the second modeling page, components selected by the user from the model library callable for the user; and in response to a component connection operation and a component parameter setting operation of the user, setting a connection relation between the components selected by the user and parameters of the components selected by the user to obtain the model of the subsystem of the construction machinery equipment.

In some embodiments, the building, on the modeling page, a model of the subsystem of the construction machinery equipment based on a model library callable for the user further comprises: presenting, on the second modeling page, function prompt information of the component selected by the user and prompt information of another component capable of being connected with the component.

In some embodiments, the adding the model of the subsystem of the construction machinery equipment into the model library comprises: checking the model of the subsystem of the construction machinery equipment; and adding the model of the subsystem of the construction machinery equipment into the model library under a condition that the checking of the model of the subsystem of the construction machinery equipment passes.

In some embodiments, the method further comprises at least one of: building a model of the construction machinery equipment according to models of the plurality of subsystems in the construction machinery equipment; or performing visualization analysis on a performance of the construction machinery equipment obtained from modeling according to a working condition set by the user and the model of the construction machinery equipment.

In some embodiments, the method further comprises setting a permission of the user, wherein the permission of the user comprises at least one of: a permission of the user for modeling, a permission of the user for accessing data of the construction machinery equipment, or a permission of the user for calling the model library.

In some embodiments, the method further comprises: under a condition that the checking of the model of the subsystem of the construction machinery equipment does not pass, presenting check failure prompt information to the user.

In some embodiments, the checking the model of the subsystem 4 the construction machinery equipment comprises: checking whether parameter setting in the model of the subsystem is beyond a range; and/or checking whether a connection relation between components in the model of the subsystem is correct.

According to a second aspect of the present disclosure, there is provided a modeling apparatus of a construction machinery equipment, comprising: a determination module configured to determine, in response to a modeling request of a user, a subsystem matched with the user from a plurality of subsystems of the construction machinery equipment; a presentation module configured to present, to the user, a modeling page of the subsystem matched with the user; a building module configured to build, on the modeling page, a model of the subsystem of the construction machinery equipment based on a model library callable for the user, wherein the model library comprises at least one of a published model of the subsystem matched with the user, a published model of another subsystem, or a published component; and a storage module configured to add the model of the subsystem of the construction machinery equipment into the model library.

According to a third aspect of the present disclosure, there is provided an electronic device, comprising: a memory; and a processor coupled to the memory, the processor being configured to perform, based on instructions stored in the memory, the modeling method of a construction machinery equipment as described above.

According to a fourth aspect of the present disclosure, there is provided a computer-storable medium having thereon stored computer program instructions which, when executed by a processor, implement the modeling method of a construction machinery equipment as described above.

According to a fifth aspect of the present disclosure, there is provided a computer program, comprising: instructions which, when executed by a processor, cause the processor to perform the modeling method of a construction machinery equipment as described above.

### BRIEF DESCRIPTION OF THE DRAWINGS

The accompanying drawings, which constitute a part of this specification, illustrate embodiments of the present disclosure and together with the description, serve to explain the principles of the present disclosure.

The present disclosure may be more clearly understood according to the following detailed description with reference to the accompanying drawings, in which:

FIG. 1 is a flow diagram illustrating a modeling method of a construction machinery equipment according to some embodiments of the present disclosure;

FIG. 2 is a schematic flow diagram illustrating a modeling method of a construction machinery equipment according to other embodiments of the present disclosure;

FIG. 3 is a schematic flow diagram illustrating a modeling method of a construction machinery equipment according to other embodiments of the present disclosure;

FIG. 4 is a schematic diagram illustrating division of modeling subsystems of a construction machinery equipment according to some embodiments of the present disclosure;

FIG. 5 is a schematic flow diagram illustrating multi-user collaborative modeling according to some embodiments of the present disclosure;

FIG. 6 is a block diagram illustrating a modeling apparatus of a construction machinery equipment according to some embodiments of the present disclosure;

FIG. 7 is a block diagram illustrating an electronic device according to some embodiments of the present disclosure;

FIG. 8 is a block diagram illustrating a computer system for implementing some embodiments of the present disclosure.

### DETAILED DESCRIPTION

Various exemplary embodiments of the present disclosure will now be described in detail with reference to the accompanying drawings. It should be noted that: relative arrangements of components and steps set forth in these embodiments, numerical expressions and numerical values do not limit the scope of the present disclosure unless specifically stated otherwise.

Furthermore, it should be understood that a size of each portion shown in the drawings is not drawn according to an actual scale for the convenience of description.

The following description of at least one exemplary embodiment is merely illustrative in nature and is in no way intended to limit this disclosure and its applications or uses.

Techniques, methods, and devices known to one of ordinary skill in the related art might not be discussed in detail, but the techniques, methods, and devices should be considered as part of the description where appropriate.

In all examples shown and discussed herein, any specific value should be construed as exemplary only and not as limiting. Therefore, other examples of the exemplary embodiments may have different values.

It should be noted that: similar reference numbers and letters refer to similar items in the following drawings, and thus, once one certain item is defined in one drawing, it need not be discussed further in subsequent drawings.

In the related art, independent modeling on each module of the construction machinery is performed by using standalone-version software, which results in low efficiency of the modeling by a user.

In view of this, the present disclosure provides a modeling method and apparatus of a construction machinery equipment, wherein different users respectively perform modeling for subsystems for which they have their own modeling authorities, and publish modeled subsystem models into a model library, so that other users can directly call the published subsystem models when performing subsystem modeling, thereby improving efficiency of the modeling of the construction machinery equipment, and implementing multi-user collaborative modeling on the construction machinery equipment.

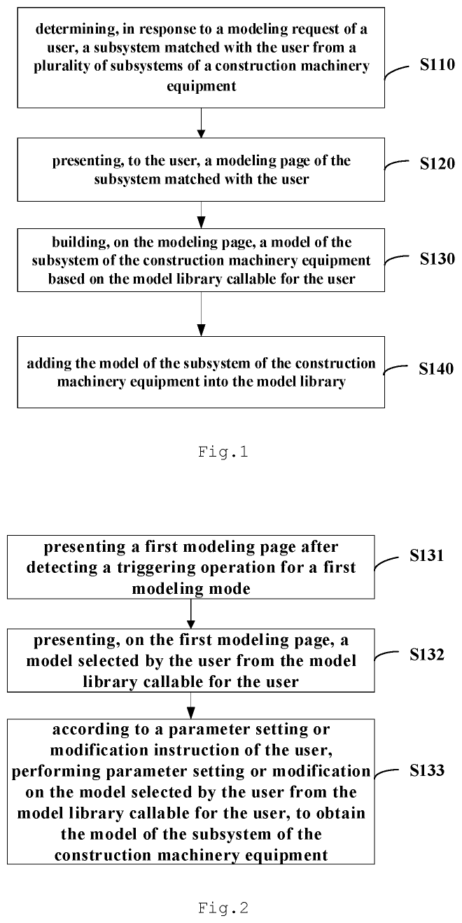

FIG. 1 is a flow diagram illustrating a modeling method of a construction machinery equipment according to some embodiments of the present disclosure. As shown in FIG. 1, the modeling method of a construction machinery equipment in some embodiments of the present disclosure comprises step S110 of determining, in response to a modeling request of a user, a subsystem matched with the user from a plurality of subsystems of a construction machinery equipment.

In some embodiments, the step S110 comprises: after receiving the modeling request of the user, acquiring modeling permission information of the user; and determining the subsystem matched with the user from the plurality of subsystems of the construction machinery equipment according to the modeling permission information of the user.

For example, a construction machinery equipment is divided into a plurality of subsystems as follows: a mechanical system, a hydraulic system, an electrical system, and a control system.

For example, the modeling request of the user is specifically a request of the user for logging in a modeling system of the construction machinery equipment. After the request of the user for logging in the modeling system of the construction machinery equipment is received, checking of username and password of the user is performed first. Under the condition that the checking of the username and the password passes, modeling permission information of the user is queried according to the username to determine a subsystem matched with the user. Under the condition that the checking of the username and the password fails, login failure prompt information is returned to the user.

For example, after successfully logging in the modeling system of the construction machinery equipment, the user sends a modeling request by tapping a specified page control (e.g., a “model” button) on a page. After the modeling request of the user is received, modeling permission information of the user is acquired; and a subsystem matched with the user is determined according to the modeling permission information of the user.

In other embodiments, the step S110 comprises: determining a construction machinery equipment selected by the user from construction machinery equipment of various types presented on a page, according to a selection operation of the user for the construction machinery equipment; acquiring modeling permission information of the user; and determining the subsystem matched with the user from a plurality of subsystems of the construction machinery equipment selected by the user according to the modeling authority information of the user.

For example, after a user successfully logs in the modeling system, construction machinery equipment of various types are presented in a form of a pop-up window at a human-machine interaction side for selecting by the user, for example, presenting, for the user, the following five types: an excavator, a pump truck, a rotary drilling rig, a road roller, and a loader. After the user selects the excavator, a subsystem matched with the user is determined from a plurality of subsystems of the excavator according to modeling permission information of the user. For example, if the acquired modeling permission information of the user indicates that a user A has a modeling authority for a hydraulic system in the excavator, the hydraulic system in the excavator is taken as a subsystem matched with the user.

In the embodiment of the present disclosure, construction machinery equipment of various types are presented to the user, and the subsystem matched with the user is determined according to a type selection operation of the user and permission information of the user, so that different users can respectively perform modeling for different subsystems, which not only improves efficiency of modeling of the construction machinery equipment, but also achieves permission control of the modeling of the construction machinery equipment, thereby effectively relieving model mishandling caused by modeling of a subsystem inconsistent with his research specialty by the user, and helping to improve effectiveness of the modeling of the construction machinery equipment.

In some embodiments, the method further comprises: before the step S110, setting a type of a supported construction machinery equipment by a model management module, and performing subsystem division and configuration for the construction machinery equipment of various types; and/or setting an permission of the user by an permission management module, wherein the permission of the user comprises at least one of: an permission of the user for modeling, an permission of the user for accessing data of the construction machinery equipment, or an permission of the user for calling a model library.

For example, the construction machinery equipment is divided into a plurality of subsystems such as a hydraulic system, a mechanical system, a control system, and an electrical system by the model management module, and an interface relation between the subsystems is set to establish communication between the subsystems.

For example, modeling permission for different subsystems are set according to different research directions of users. For example, if a research direction of a user A is a hydraulic system, the user A is given modeling and modification permission for the hydraulic system, to allow the user A to perform modeling for the hydraulic system, and the user A is given an access permission for each subsystem in the construction machinery equipment, to allow the user A to view an interface connection relation between a hydraulic system model built by the user A himself and a whole vehicle model.

The method further comprises step S120 of presenting, to the user, a modeling page of the subsystem matched with the user.

In some embodiments, the modeling page of the subsystem matched with the user comprises: a presentation area for a model library callable for the user. The model library comprises at least one of a published model of the subsystem matched with the user, a published model of another subsystem, or a published component.

The method further comprises step S130 of building, on the modeling page, a model of the subsystem of the construction machinery equipment based on the model library callable for the user.

In some embodiments, the model of the subsystem of the construction machinery equipment is built on the modeling page based on a model or a component of the model in the model library callable for the user.

In some embodiments, various modeling modes are supported, for example, parametric modeling, and general modeling.

The method further comprises step S140 of adding the model of the subsystem of the construction machinery equipment into the model library.

In some embodiments, the step S140 comprises: checking the model of the subsystem of the construction machinery equipment; and adding the model of the subsystem of the construction machinery equipment into the model library and publishing the model of the subsystem under the condition that the checking of the model of the subsystem of the construction machinery equipment passes.

Exemplarily, the checking the model of the subsystem of the construction machinery equipment comprises: checking whether parameter setting in the model of the subsystem is beyond a range, and/or checking whether a connection relation between components in the model is correct.

In some embodiments, the modeling method of a construction machinery equipment further comprises: under the condition that the checking of the model of the subsystem of the construction machinery equipment does not pass, presenting check failure prompt information to the user.

In the embodiments of the present disclosure, the model of the subsystem that is built by the user is added into the model library, so that another user can directly call the model of the subsystem from the model library, and perform modeling according to the model of the subsystem, which improves effectiveness and rapidity of the modeling. Further, automatic check is performed on the built model of the subsystem first, and then the model of the subsystem is published and added into the library after the check passes, which helps to reduce an error rate of the modeling. After the check on the model fails, prompt information such as a check failure reason is presented to the user, which is convenient for the user to discover a modeling error, reduces difficulty of the modeling, and improves efficiency of the modeling.

In some embodiments, the modeling method of a construction machinery equipment further comprises at least one of: building a model of the construction machinery equipment according to models of the plurality of subsystems in the construction machinery equipment; and performing visualization analysis on a performance of the construction machinery equipment obtained from the modeling according to a working condition set by the user and the model of the construction machinery equipment. For example, the user A may, after completing modeling of the hydraulic system, integrate a model of the hydraulic system into the whole vehicle system and perform overall simulation on the whole vehicle system.

In the embodiments of the present disclosure, the collaborative modeling is achieved through the above steps, which not only can improve the modeling efficiency of the construction machinery equipment, but also can improve convenience and effectiveness of the modeling of the construction machinery equipment.

FIG. 2 is a schematic flow diagram illustrating building a model of a subsystem of a construction machinery equipment according to some embodiments of the present disclosure. As shown in FIG. 2, in some embodiments of the present disclosure, the step (i.e., the step S130) of building a model of the subsystem of the construction machinery equipment specifically comprises step S131 of presenting a first modeling page after detecting a triggering operation for a first modeling mode.

In some embodiments, the modeling page is provided with a selection component (e.g., a button named “parametric modeling”) for the first modeling mode and a selection component (e.g., a button named “general modeling”) for a second modeling mode. The first modeling page is presented after it is detected that the user taps the selection component for the first modeling mode.

The step 130 further comprises step S132 of presenting, on the first modeling page, a model selected by the user from the model library callable for the user.

The first modeling page comprises a presentation area for the model library callable for the user. The model library comprises at least one of a published model of the subsystem matched with the user, a published model of another subsystem, or a published component.

In some embodiments, the model library is presented to the user in a form of a tree structure. The user, upon the modeling, selects the published model of the subsystem from the model library callable for the user and drags it to a designated area for presentation.

The step 130 further comprises step S133 of performing parameter setting or modification on the model selected by the user from the model library callable for the user according to a parameter setting or modification instruction of the user, to obtain the model of the subsystem of the construction machinery equipment.

In some embodiments, parameter setting or modification instructions of the user are received through a model parameter setting or modification page. According to the instructions, parameters of components in the model selected by the user are set or modified to obtain one new model of the subsystem of the construction machinery equipment.

In the embodiments of the present disclosure, the parametric modeling for the subsystem is achieved through the above steps. By adopting such a modeling mode, efficiency of the modeling of the construction machinery equipment can be improved, and difficulty of the modeling of the construction machinery equipment is reduced.

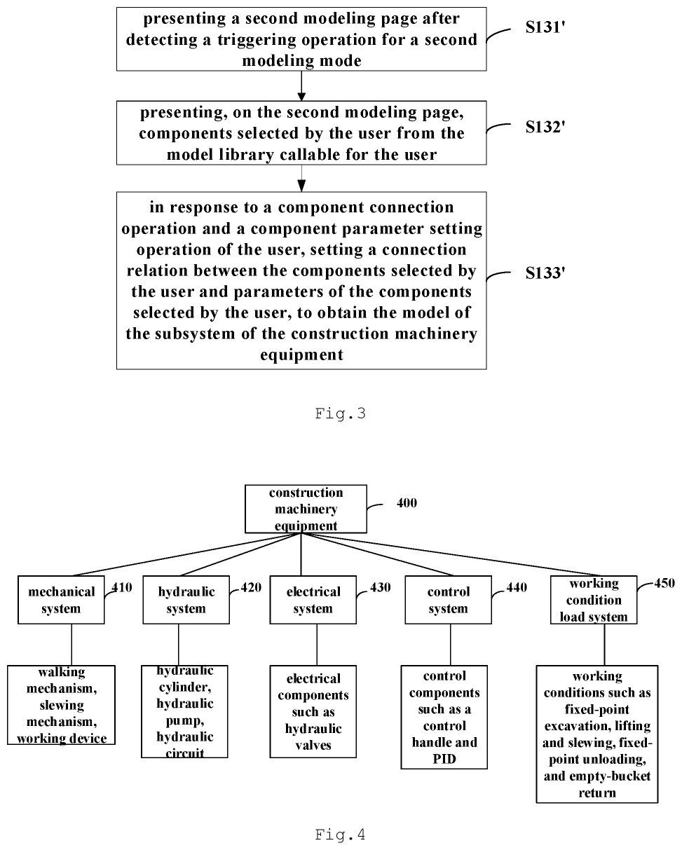

FIG. 3 is a schematic flow diagram illustrating building a model of a subsystem of a construction machinery equipment according to some embodiments of the present disclosure. As shown in FIG. 3, in some embodiments of the present disclosure, the step (i.e., the step S130) of building a model of the subsystem of the construction machinery equipment specifically comprises step S131′ of presenting a second modeling page after detecting a triggering operation for a second modeling mode.

In some embodiments, the modeling page is provided with the selection component (e.g., the button named “parametric modeling”) for the first modeling mode and the selection component (e.g., the button named “general modeling”) for the second modeling mode. The second modeling page is presented after it is detected that the user taps the selection component for the second modeling mode.

The step 130 further comprises step S132′ of presenting, on the second modeling page, components selected by the user from the model library callable for the user.

The second modeling page comprises a presentation area for the model library callable for the user. The model library comprises at least one of a published model of the subsystem matched with the user, a published model of another subsystem, or a published component.

In some embodiments, the second modeling page comprises one or more model libraries callable for the user. A model library selected by the user is loaded into the modeling space for the user according to the operation of selecting the model library by the user.

In some embodiments, the step S130 further comprises presenting, on the second modeling page, function prompt information of the component selected by the user and prompt information of another component capable of being connected with the component.

For example, after a user drags a hydraulic cylinder component in the model library to a designated area, the system queries a function of the hydraulic cylinder component and determines another component capable of being connected with the hydraulic cylinder component, and presents prompt information of the function of the hydraulic cylinder component and the another component capable of being connected with the hydraulic cylinder component to the user, thereby reducing difficulty of the modeling, and improving efficiency of the modeling.

The step 130 further comprises step S133′ of setting a connection relation between the components selected by the user and parameters of the components selected by the user in response to a component connection operation and a component parameter setting operation of the user, to obtain the model of the subsystem of the construction machinery equipment.

In the embodiments of the present disclosure, the general modeling for the subsystem is achieved through the above steps. By supporting the various modeling modes comprising the parametric modeling and general modeling, flexibility of the modeling of the construction machinery equipment can be improved and modeling experience of the user can be enhanced.

FIG. 4 is a schematic diagram illustrating division of modeling subsystems of a construction machinery equipment according to some embodiments of the present disclosure. In some embodiments of the present disclosure, the construction machinery equipment is divided into a plurality of modeling subsystems in advance by the model management module, and a respective modeling component is provided for each modeling subsystem. As shown in FIG. 4, a construction machinery equipment 400 is divided into the following modeling subsystems: a mechanical system 410, a hydraulic system 420, an electrical system 430, a control system 440, and a working condition load system 450. Further, interfaces of the subsystems can be set and managed to establish effective connections between the subsystems, so that communication between the subsystems is achieved.

In some embodiments, the mechanical system 410 is provided with the following modeling components: a walking mechanism, a slewing mechanism, a working device.

In some embodiments, the hydraulic system 420 is provided with the following components: a hydraulic cylinder, a hydraulic pump, a hydraulic circuit.

In some embodiments, the electrical system 430 is provided with electrical components such as hydraulic valves.

In some embodiments, the control system 440 is provided with control components such as a control handle and PID.

In some embodiments, the working condition load system 450 is provided with components for working conditions such as fixed-point excavation, lifting and slewing, fixed-point unloading, and empty-bucket return.

In the embodiment of the present disclosure, the whole vehicle system of the construction machinery equipment is divided into the plurality of subsystems such as a mechanical system, a hydraulic system, a control system, and an electrical system, so that it is convenient for different users to subsequently respectively perform modeling for subsystems for which they have modeling permission, which not only helps to improve efficiency of the modeling, but also helps to avoid misoperation caused by modeling of a model in an unknown field due to different research directions of the users.

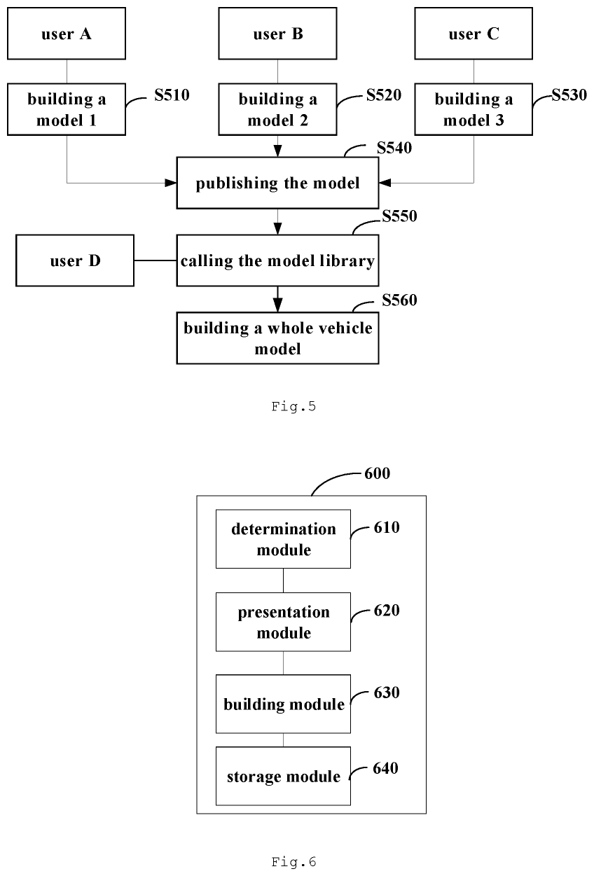

FIG. 5 is a schematic flow diagram illustrating multi-user collaborative modeling according to some embodiments of the present disclosure. As shown in FIG. 5, the flow of the multi-user collaborative modeling according to the embodiments of the present disclosure comprises step S510 of building a model 1 by the user A.

For example, the user A builds the model 1 for a subsystem (e.g., a hydraulic system) for which he has a modeling permission.

The flow of the multi-user collaborative modeling further comprises step S520 of building a model 2 by a user B.

For example, the user B builds the model 2 for a subsystem (e.g., an electrical system) for which he has a modeling permission.

The flow of the multi-user collaborative modeling further comprises step S530 of building a model 3 by a user C.

For example, the user C builds the model 3 for a subsystem (e.g., a mechanical system) for which he has a modeling permission.

The flow of the multi-user collaborative modeling further comprises step S540 of publishing the model.

After the users A, B, C have respectively built the models of the subsystems, their built models are added into a model library and published.

The flow of the multi-user collaborative modeling further comprises step S550 of calling the model library by a user D.

The flow of the multi-user collaborative modeling further comprises step S560 of building a whole vehicle model by the user D.

For example, the user D may, upon the modeling, from the model library, call the subsystem models 1, 2, 3, built by the users A, B, C, and build the whole vehicle model of the construction machinery equipment based on the subsystem models 1, 2, 3.

In the embodiments of the present disclosure, the multi-user collaborative modeling can be achieved through the above steps, which improves efficiency of the modeling of the construction machinery equipment.

FIG. 6 is a block diagram illustrating a modeling apparatus of a construction machinery equipment according to some embodiments of the present disclosure. As shown in FIG. 6, a modeling apparatus 600 of a construction machinery equipment according to the embodiments of the present disclosure comprises: a determination module 610, a presentation module 620, a building module 630, and a storage module 640.

The determination module 610 is configured to determine, in response to a modeling request of a user, a subsystem matched with the user from a plurality of subsystems of the construction machinery equipment.

In some embodiments, after receiving the modeling request of the user, the determination module 610 acquires modeling permission information of the user; and the determination module 610 determines the subsystem matched with the user from the plurality of subsystems of the construction machinery equipment according to the modeling permission information of the user.

For example, the modeling request of the user is specifically a request of the user for logging in a modeling system of the construction machinery equipment. After the request of the user for logging in the modeling system of the construction machinery equipment is received, checking of username and password of the user is first performed. Under the condition that the checking of the username and the password passes, the determination module 610 queries modeling permission information of the user according to the username to determine the subsystem matched with the user. Under the condition that the check on the username and the password fails, the determination module 610 returns login failure prompt information to the user.

In other embodiments, the determination module 610 determines construction machinery equipment selected by the user from construction machinery equipment of various types presented on a page, according to a selection operation of the user for the construction machinery equipment; acquires modeling permission information of the user; and determines the subsystem matched with the user from a plurality of subsystems of the construction machinery equipment selected by the user according to the modeling permission information of the user

For example, after a user successfully logs in a modeling system, construction machinery equipment of various types are presented in a form of a pop-up window at a human-machine interaction side for selecting by the user, for example, presenting, for the user, the following five types: an excavator, a pump truck, a rotary drilling rig, a road roller, and a loader. After the user selects the excavator, a subsystem matched with the user is determined from a plurality of subsystems of the excavator according to modeling permission information of the user. For example, if the acquired modeling permission information of the user indicates that the user A has a modeling permission for a hydraulic system in the excavator, the hydraulic system in the excavator is taken as a subsystem matched with the user.

In the embodiments of the present disclosure, construction machinery equipment of various types are presented to the user, and a subsystem matched with the user is determined according to a type selection operation of the user and permission information of the user, so that different users can respectively perform modeling for different subsystems, which not only improves efficiency of modeling of the construction machinery equipment, but also achieves permission control of the modeling of the construction machinery equipment, thereby effectively relieving model misoperation caused by modeling of a subsystem inconsistent with his research specialty by the user, and helping to improve effectiveness of the modeling of the construction machinery equipment.

The presentation module 620 is configured to present, to the user, a modeling page of the subsystem matched with the user.

The building module 630 configured to build, on the modeling page, a model of the subsystem of the construction machinery equipment based on a model library callable for the user.

The model library comprises at least one of a published model of the subsystem matched with the user, a published model of another subsystem, or a published component.

In some embodiments, the building, by the building module 630, a model of the subsystem of the construction machinery equipment comprises: presenting a first modeling page after detecting triggering operation for a first modeling mode; presenting, on the first modeling page, a model selected by the user from the model library callable for the user; and according to a parameter setting or modification instruction of the user, performing parameter setting or modification on the model selected by the user from the model library callable for the user to obtain the model of the subsystem of the construction machinery equipment.

In some embodiments, the building, by the building module 630, a model of the subsystem of the construction machinery equipment comprises: presenting a second modeling page after detecting a triggering operation for a second modeling mode; presenting, on the second modeling page, components selected by the user from the model library callable for the user; and in response to a component connection operation and a component parameter setting operation of the user, setting a connection relation between the components selected by the user and parameters of the components selected by the user to obtain the model of the subsystem of the construction machinery equipment.

The storage module 640 is configured to add the model of the subsystem of the construction machinery equipment into the model library.

In the embodiments of the present disclosure, with the above apparatus, the collaborative modeling for the construction machinery equipment is achieved, which not only can improve efficiency of the modeling of the construction machinery equipment, but also can improve convenience and effectiveness of the modeling of the construction machinery equipment.

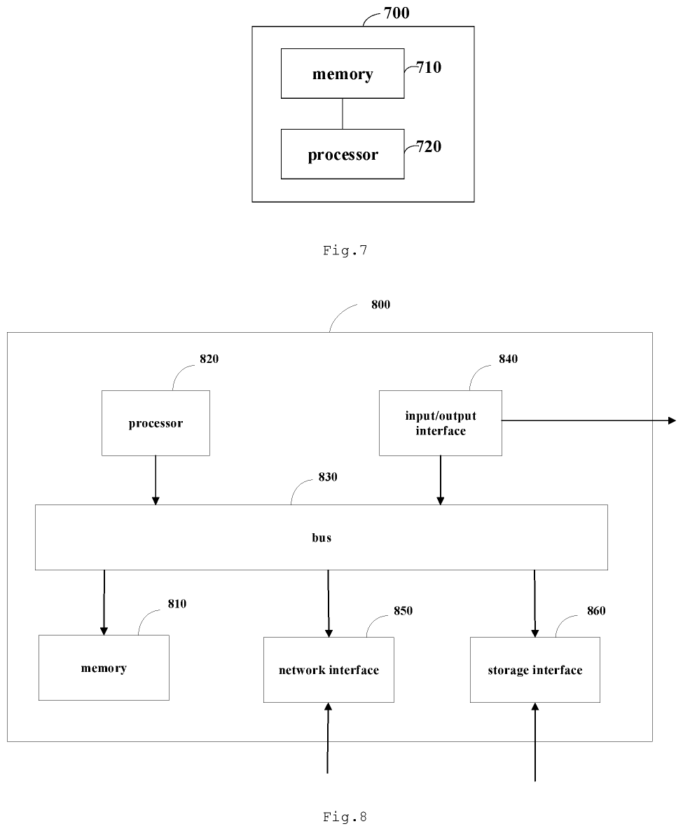

FIG. 7 is a block diagram illustrating an electronic device according to other embodiments of the present disclosure.

As shown in FIG. 7, an electronic device 700 comprises a memory 710; and a processor 720 coupled to the memory 710. The memory 710 is used for storing instructions for performing corresponding embodiments of the modeling method of a construction machinery equipment. The processor 720 is configured to perform, based on the instructions stored in the memory 710, the modeling method of a construction machinery equipment in any of the embodiments of the present disclosure.

FIG. 8 is a block diagram illustrating a computer system for implementing some embodiments of the present disclosure.

As shown in FIG. 8, a computer system 800 may be presented in a form of a general-purpose computing device. The computer system 800 comprises a memory 810, a processor 820, and a bus 830 connecting various system components.

The memory 810 may comprise, for example, a system memory, non-volatile storage medium, and the like. The system memory has thereon stored, for example, an operating system, an application, a boot loader, and other programs, etc. The system memory may comprise a volatile storage medium, for example, a random access memory (RAM) and/or a cache memory. The non-volatile storage medium may has thereon stored, for example, instructions for performing corresponding embodiments of at least one of the modeling methods of a construction machinery equipment. The non-volatile storage medium comprises, but is not limited to, a magnetic disk memory, optical memory, flash memory, and the like.

The processor 820 may be implemented using discrete hardware components, such as a general-purpose processor, a digital signal processor (DSP), an application specific integrated circuit (ASIC), a field programmable gate array (FPGA) or other programmable logic devices, a discrete gate or transistor. Accordingly, each of the modules such as the determination module, the presentation module, the building module, and the storage module may be implemented by operating, by a central processing unit (CPU), instructions for performing the corresponding steps in the memory, or may be implemented by a dedicated circuit for performing the corresponding steps.

The bus 830 may use any of a variety of bus architectures. For example, the bus architecture comprises, but is not limited to, an industry standard architecture (ISA) bus, a micro channel architecture (MCA) bus, and a peripheral component interconnect (PCI) bus.

The computer system 800 may also comprise an input/output interface 840, a network interface 850, a storage interface 860, and the like. These interfaces 840, 850, 860 and the memory 810 may be connected with the processor 820 via the bus 830. The input/output interface 840 may provide a connection interface for input/output devices such as a display, a mouse, and a keyboard. The network interface 850 provides a connection interface for various networking devices. The storage interface 860 provides a connection interface for external storage devices such as a floppy disk, a USB flash disk, and an SD card.

Various aspects of the present disclosure are described herein with reference to flow diagrams and/or block diagrams of the method, apparatus and computer program product according to the embodiments of the present disclosure. It should be understood that each block of the flow diagrams and/or block diagrams, and a combination of blocks in the flow diagrams and/or block diagrams, may be implemented by computer-readable program instructions.

These computer-readable program instructions may be provided to a processor of a general-purpose computer, special-purpose computer, or other programmable apparatuses to produce a machine, such that execution of the instructions by the processor creates a means for implementing the functions specified in one or more blocks in the flow diagrams and/or block diagrams.

These computer-readable program instructions may also be stored in a computer-readable memory, wherein these instructions cause a computer to work in a specific manner, thereby producing an article of manufacture, which comprises instructions for implementing the functions specified in one or more blocks in the flow diagrams and/or block diagrams.

The present disclosure may take a form of an entire hardware embodiment, an entire software embodiment or an embodiment combining software and hardware aspects.

By means of the modeling method and apparatus of a construction machinery equipment in the above embodiments, efficiency of the modeling of the construction machinery equipment can be improved.

So far, the modeling method and apparatus of a construction machinery equipment according to the present disclosure have been described in detail. Some details well known in the art have not been described in order to avoid obscuring the concepts of the present disclosure. Those skilled in the art can, according to the foregoing description, fully appreciate how to implement the technical solution disclosed herein.

1. A modeling method of a construction machinery equipment, comprising:
in response to a modeling request of a user, determining a subsystem matched with the user from a plurality of subsystems of the construction machinery equipment;
presenting, to the user, a modeling page of the subsystem matched with the user;
building, on the modeling page, a model of the subsystem of the construction machinery equipment based on a model library callable for the user, wherein the model library comprises at least one of a published model of the subsystem matched with the user, a published model of another subsystem, or a published component; and
adding the model of the subsystem of the construction machinery equipment into the model library.

2. The modeling method of a construction machinery equipment according to claim 1, wherein the determining a subsystem matched with the user from a plurality of subsystems of the construction machinery equipment comprises:
determining a construction machinery equipment selected by the user from construction machinery equipment of various types presented on a page, according to a selection operation of the user for the construction machinery equipment;
acquiring modeling permission information of the user; and
determining the subsystem matched with the user from the plurality of subsystems of the construction machinery equipment selected by the user, according to the modeling permission information of the user.

3. The modeling method of a construction machinery equipment according to claim 1, wherein the determining a subsystem matched with the user from a plurality of subsystems of the construction machinery equipment comprises:
acquiring modeling permission information of the user; and
determining the subsystem matched with the user from the plurality of subsystems of the construction machinery equipment, according to the modeling permission information of the user.

4. The modeling method of a construction machinery equipment according to claim 1, wherein the building, on the modeling page, a model of the subsystem of the construction machinery equipment based on a model library callable for the user comprises:
presenting a first modeling page after detecting a triggering operation for a first modeling mode;
presenting, on the first modeling page, a model selected by the user from the model library callable for the user; and
according to a parameter setting or modification instruction of the user, performing parameter setting or modification on the model selected by the user from the model library callable for the user, to obtain the model of the subsystem of the construction machinery equipment.

5. The modeling method of a construction machinery equipment according to claim 4, wherein the building, on the modeling page, a model of the subsystem of the construction machinery equipment based on a model library callable for the user further comprises:
presenting a second modeling page after detecting a triggering operation for a second modeling mode;
presenting, on the second modeling page, components selected by the user from the model library callable for the user; and
in response to a component connection operation and a component parameter setting operation of the user, setting a connection relation between the components selected by the user and parameters of the components selected by the user, to obtain the model of the subsystem of the construction machinery equipment.

6. The modeling method of a construction machinery equipment according to claim 5, wherein the building, on the modeling page, a model of the subsystem of the construction machinery equipment based on a model library callable for the user further comprises:
presenting, on the second modeling page, function prompt information of the component selected by the user and prompt information of another component capable of being connected with the component.

7. The modeling method of a construction machinery equipment according to claim 1, wherein the adding the model of the subsystem of the construction machinery equipment into the model library comprises:
checking the model of the subsystem of the construction machinery equipment; and
adding the model of the subsystem of the construction machinery equipment into the model library under a condition that the checking of the model of the subsystem of the construction machinery equipment passes.

8. The modeling method of a construction machinery equipment according to claim 1, further comprising at least one of:
building a model of the construction machinery equipment according to models of the plurality of subsystems of the construction machinery equipment; or
performing visualization analysis on a performance of the model of the construction machinery equipment obtained from modeling according to a working condition set by the user.

9. The modeling method of a construction machinery equipment according to claim 1, further comprising setting a permission of the user, wherein the permission of the user comprises at least one of: a permission of the user for modeling, a permission of the user for accessing data of the construction machinery equipment, or a permission of the user for calling the model library.

10. The modeling method of a construction machinery equipment according to claim 7, further comprising:
under a condition that the checking of the model of the subsystem of the construction machinery equipment does not pass, presenting check failure prompt information to the user.

11. The modeling method of a construction machinery equipment according to claim 7, wherein the checking the model of the subsystem of the construction machinery equipment comprises:
checking whether parameter setting in the model of the subsystem is beyond a range; and/or
checking whether a connection relation between components in the model of the subsystem is correct.

12. (canceled)

13. An electronic device, comprising:
a memory; and
a processor coupled to the memory, the processor being configured to perform, based on instructions stored in the memory, a modeling method of a construction machinery equipment comprising:
in response to a modeling request of a user, determining a subsystem matched with the user from a plurality of subsystems of the construction machinery equipment;
presenting, to the user, a modeling page of the subsystem matched with the user;
building, on the modeling page, a model of the subsystem of the construction machinery equipment based on a model library callable for the user, wherein the model library comprises at least one of a published model of the subsystem matched with the user, a published model of another subsystem, or a published component; and
adding the model of the subsystem of the construction machinery equipment into the model library.

14. A non-transitory computer-storable medium having thereon stored computer program instructions which, when executed by a processor, implement a modeling method of a construction machinery equipment comprising:
in response to a modeling request of a user, determining a subsystem matched with the user from a plurality of subsystems of the construction machinery equipment;
presenting, to the user, a modeling page of the subsystem matched with the user;
building, on the modeling page, a model of the subsystem of the construction machinery equipment based on a model library callable for the user, wherein the model library comprises at least one of a published model of the subsystem matched with the user, a published model of another subsystem, or a published component; and
adding the model of the subsystem of the construction machinery equipment into the model library.

15. (canceled)

16. The electronic device according to claim 13, wherein the determining a subsystem matched with the user from a plurality of subsystems of the construction machinery equipment comprises:
determining a construction machinery equipment selected by the user from construction machinery equipment of various types presented on a page, according to a selection operation of the user for the construction machinery equipment;
acquiring modeling permission information of the user; and
determining the subsystem matched with the user from the plurality of subsystems of the construction machinery equipment selected by the user, according to the modeling permission information of the user.

17. The electronic device according to claim 13, wherein the determining a subsystem matched with the user from a plurality of subsystems of the construction machinery equipment comprises:
acquiring modeling permission information of the user; and
determining the subsystem matched with the user from the plurality of subsystems of the construction machinery equipment, according to the modeling permission information of the user.

18. The electronic device according to claim 13, wherein the building, on the modeling page, a model of the subsystem of the construction machinery equipment based on a model library callable for the user comprises:
presenting a first modeling page after detecting a triggering operation for a first modeling mode;
presenting, on the first modeling page, a model selected by the user from the model library callable for the user; and
according to a parameter setting or modification instruction of the user, performing parameter setting or modification on the model selected by the user from the model library callable for the user, to obtain the model of the subsystem of the construction machinery equipment.

19. The electronic device according to claim 18, wherein the building, on the modeling page, a model of the subsystem of the construction machinery equipment based on a model library callable for the user further comprises:
presenting a second modeling page after detecting a triggering operation for a second modeling mode;
presenting, on the second modeling page, components selected by the user from the model library callable for the user; and
in response to a component connection operation and a component parameter setting operation of the user, setting a connection relation between the components selected by the user and parameters of the components selected by the user, to obtain the model of the subsystem of the construction machinery equipment.

20. The electronic device according to claim 19, wherein the building, on the modeling page, a model of the subsystem of the construction machinery equipment based on a model library callable for the user further comprises:
presenting, on the second modeling page, function prompt information of the component selected by the user and prompt information of another component capable of being connected with the component.

21. The electronic device according to claim 13, wherein the adding the model of the subsystem of the construction machinery equipment into the model library comprises:
checking the model of the subsystem of the construction machinery equipment; and
adding the model of the subsystem of the construction machinery equipment into the model library under a condition that the checking of the model of the subsystem of the construction machinery equipment passes.

22. The electronic device according to claim 13, wherein the processor is further configured to perform at least one of:
building a model of the construction machinery equipment according to models of the plurality of subsystems of the construction machinery equipment; or
performing visualization analysis on a performance of the model of the construction machinery equipment obtained from modeling according to a working condition set by the user.
